(19) United States
(12) Patent Application Publication
(10) Pub. No.: US 2026/0055845 A1
(43) Pub. Date: Feb. 26, 2026

(54) DISPLAY SUPPORT BRACKET

(71) Applicant: TILTA INC., Burbank, CA (US)

(72) Inventors: Sen WU, Shenzhen (CN); Weihan SHE, Shenzhen (CN); Wenping ZENG, Shenzhen (CN); Kefeng ZHOU, Shenzhen (CN)

(21) Appl. No.: 19/302,937

(22) Filed: Aug. 18, 2025

(30) Foreign Application Priority Data
Aug. 20, 2024 (CN) 2024220274130

(51) Int. Cl. F16M 13/02; F16M 11/08; F16M 11/20

(52) U.S. Cl. CPC F16M 13/02; F16M 11/08; F16M 11/2028

(57) ABSTRACT

A display support bracket includes: a mounting member for securing to an installation base; a connecting arm attached to the mounting member; and a display carrier, which includes a connection head, a rotating connection assembly, and a mounting base. The connection head is movably connected to the end of the connecting arm opposite the mounting member. The rotating connection assembly is rotatably connected to the connection head around a first rotation axis, and the mounting base is rotatably mounted to the rotating connection assembly around a second rotation axis. The mounting base is designed for installing a display. This design addresses the existing issues of poor adjustability and inconvenient operation of display support brackets.

### CROSS-REFERENCE TO RELATED APPLICATIONS

The present application for patent claims priority to and the benefit of pending Chinese Application No. 2024220274130, filed on Aug. 20, 2024, which is hereby expressly incorporated by reference herein as if fully set forth below in its entirety and for all applicable purposes.

### TECHNICAL FIELD

The present disclosure pertains to the technical field of display devices, specifically to a display support bracket.

### INTRODUCTION

In the filming industry, displays are frequently employed to showcase camera shooting effects. With the widespread adoption of displays, the use of display support brackets has also become common. These brackets can be installed on bases such as cameras or workbenches, enabling users to position displays in desired workspaces. However, while current display support brackets can secure and mount displays, their adjustability is limited and poor, failing to meet practical demands and causing inconvenience for users.

### BRIEF SUMMARY

Aspects of the present disclosure provide a display support bracket to address the existing issues of poor adjustability and inconvenient operation of display support brackets.

In some aspects, a display support bracket is provided, including:
a mounting member for securing to an installation base;
a connecting arm attached to the mounting member; and
a display carrier, which includes a connection head, a rotating connection assembly, and a mounting base. The connection head is movably connected to the end of the connecting arm opposite the mounting member. The rotating connection assembly is rotatably connected to the connection head around a first rotation axis, and the mounting base is rotatably mounted to the rotating connection assembly around a second rotation axis. The mounting base is designed for installing a display.

Aspects of the present disclosure, the display support bracket connects the mounting member and the display carrier via the connecting arm, allowing the display carrier to move relative to the mounting member, facilitating positional adjustments during use. The display carrier, including the connection head, rotating connection assembly, and mounting base, enables the rotating connection assembly to rotate relative to the connection head around the first axis and the mounting base to rotate relative to the rotating connection assembly around the second axis. This multi-stage rotation further adjusts the orientation and angle of the mounting base, enhancing the adjustability and usability of the display support bracket.

### BRIEF DESCRIPTION OF THE DRAWINGS

To further illustrate the technical solutions in the embodiments, the following provides a brief description of the accompanying drawings for implementing exemplary embodiments of the present disclosure. The drawings represent only exemplary embodiments, and other derived configurations may be obtained by those skilled in the art without inventive effort.

FIG. 1 is a diagram illustrating a display support bracket according to some aspects of the disclosure.

FIG. 2 is a diagram illustrating a mounting member according to some aspects of the disclosure.

FIG. 3 is a diagram illustrating the mounting member according to some aspects of the disclosure;

FIG. 4 is a side view of the display support bracket from a first perspective according to some aspects of the disclosure.

FIG. 5 is a cross-sectional view taken along section line A-A of a connecting arm and a display carrier portion in FIG. 4.

FIG. 6 is a side view of the display support bracket from a second perspective according to some aspects of the disclosure.

FIG. 7 is a cross-sectional view taken along section line B-B of the display carrier portion in FIG. 6.

FIG. 8 is an exploded diagram illustrating a connection body and a mounting base according to some aspects of the disclosure.

FIG. 9 is a cross-sectional view taken along section line C-C of the mounting base portion in FIG. 6.

FIG. 10 is an exploded diagram illustrating an adapter base and a base body according to some aspects of the disclosure.

In the drawings:
100, mounting member; 110, fixed portion; 120, movable portion; 130, clamping lever; 140, clamping cavity; 150, through-hole mounted desk clamp; 160, edge-mounted desk clamp;
200, connecting arm; 210, main arm; 211, branch arm; 212, threaded through hole; 213, adjustment through hole; 214, pivot hole; 220, adjustment shaft; 230, rotating connecting shaft; 231, fifth bushing;
300, display carrier;
310, connection head; 311, shaft passage hole; 312, third bushing; 3121, sleeve portion; 3122, damping portion; 313, positioning protrusion; 314, bearing; 315, expansion sleeve; 3151, expansion end; 3152, fixed end; 3153, annular boss; 3154, inclined surface; 316, adjustment column; 3161, tapered surface; 317, fourth bushing;
320, rotating connection assembly; 321, connection body; 3211, connection hole; 3212, second bushing; 3213, cylindrical sleeve portion; 3214, first bushing; 3215, convex ring; 3216, limiting protrusion; 322, rotating mating member; 3221, abutment limiting surface; 3222, annular protrusion;
330, mounting base; 331, base body; 3311, quick-release plate; 3312, locking groove; 332, adapter base; 3321, stepped hole; 3322, spacer washer; 3323, embedding groove; 3324, receiving cavity; 3325, limiting groove; 3326, quick-release groove; 333, locking component; 3331, locking member; 33311, locking protrusion; 33312, second engagement portion; 3332, locking switch; 33321, elastic member; 33322, first engagement portion.

### DETAILED DESCRIPTION

In some aspects of this disclosure, a display support bracket can include a connecting arm 200 connected to a mounting member 100 and a display carrier 300, allowing the display carrier 300 to move relative to the mounting member 100, facilitating positional adjustments of a display that can be mounted on the display carrier 300. The display carrier 300 can include a connection head 310, a rotating connection assembly 320, and a mounting base 330, that enables the display mounted on the mounting base 330 to adjust its angle and orientation, enhancing the adjustability and usability of the display support bracket.

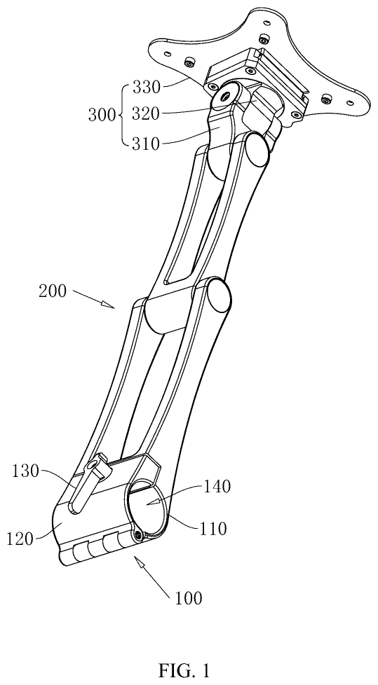

In some aspects, referring to FIG. 1-10, the display support bracket can include the mounting member 100, the connecting arm 200, and the display carrier 300 that are connected sequentially. The mounting member 100 can be used for securing the display support bracket to an installation base (e.g., a rack or a rod), and the display carrier 300 can be used for mounting a display on the display carrier.

The mounting member 100 secures the display support bracket to the installation base. In different embodiments, depending on the installation base in various application scenarios, the mounting member 100 can take different forms.

In some aspects, when the installation base is a support rod or column on a director's cart, the mounting member 100 can be a pipe clamp. In some aspects, referring to FIG. 1, the pipe clamp can be integrally formed at one end of the connecting arm 200. For example, the pipe clamp includes a fixed portion 110, a movable portion 120, and a clamping lever 130. One end of the movable portion 120 is hinged to the fixed portion 110, while the other end serves as a movable end connected to the fixed portion 110 via the clamping lever 130. The movable portion 120 and fixed portion 110 together form a clamping cavity 140. After inserting the support rod or column into the clamping cavity 140, the clamping lever 130 is adjusted to lock the movable portion 120, securing the support rod or column in the clamping cavity 140 to complete the installation. In other embodiments, pipe clamps of different structural forms can be used, and the pipe clamp can also be detachably connected to the connecting arm 200, provided it can be securely fixed to the connecting arm 200.

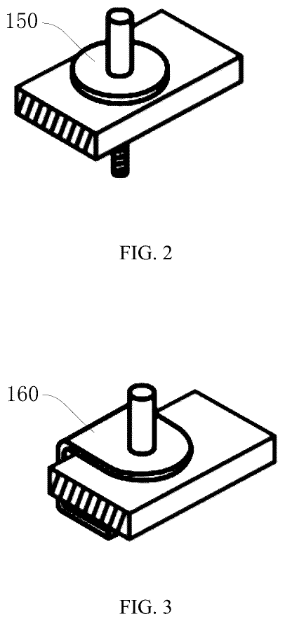

In some aspects, when the installation base is a desktop or panel, the mounting member 100 can be a desk clamp. Exemplarily, referring to FIG. 2, when the desktop or panel has mounting holes, the mounting member 100 can utilize a through-hole mounted desk clamp 150. In some aspects, the desk clamp can include a perforated column and two clamping locking members 3331 disposed on the perforated column. The perforated column is inserted through the hole on the desktop or panel, and the clamping locking members 3331 are adjusted to clamp the desktop or panel in between, thereby completing the installation and fixation of the mounting member 100. Referring to FIG. 3, when installation is located at the edge of the desktop or panel, the mounting member 100 can employ an edge-mounted desk clamp 160 with a clamping opening. In some aspects, the desk clamp includes a C-shaped clamping member, with one side forming the clamping opening. The C-shaped clamping member can be provided with set screws on one or both sides of the clamping opening. During use, the clamping opening is engaged with the edge of the desktop or panel, and the set screws are adjusted to clamp the desktop or panel within the clamping opening.

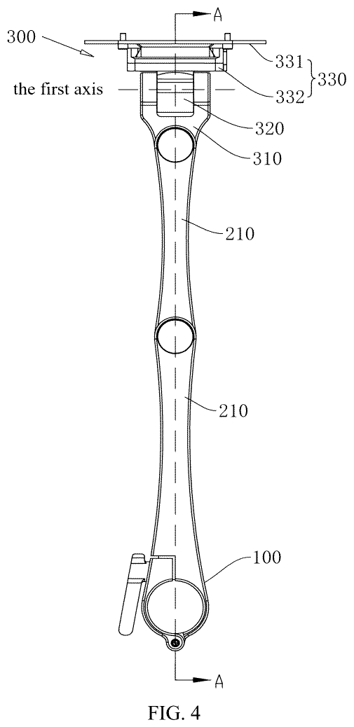

Referring to FIG. 4, the connecting arm 200 is attached to the mounting member 100. The connecting arm 200 includes at least one main arm 210. When the connecting arm 200 includes at least two main arms 210, the main arms 210 are sequentially and movably connected. Increasing the number of main arms 210 can expand the range of motion and degrees of freedom of the display carrier 300, further enhancing the adjustability of the display support bracket. Exemplarily, the connecting arm 200 includes two main arms 210, which are rotatably connected to each other. The mounting member 100 and the display carrier 300 are respectively positioned at the distal ends of the two main arms 210.

In other examples, the number of main arms 210 can be set to one, three, or four as needed. The rotation axes between the main arms 210 can be parallel, perpendicular, or alternately arranged, depending on practical requirements.

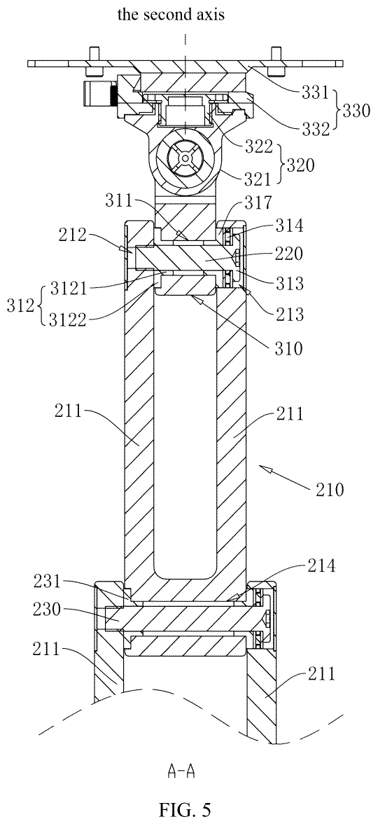

In some aspects, referring to FIG. 5, one of the two rotatably connected main arms 210 is provided with a rotating connecting shaft 230, while the other is provided with a pivot hole 214. The rotating connecting shaft 230 is inserted through the pivot hole 214 to enable the two main arms 210 to rotate relative to each other. A fifth bushing 231 is sleeved on the rotating connecting shaft 230, with at least part of the fifth bushing 231 retained between the two main arms 210 to provide damping, ensuring that the rotation between the two main arms 210 exhibits a damping effect.

Referring to FIGS. 4 and 5, the display carrier 300 includes a connection head 310, a rotating connection assembly 320, and a mounting base 330. The connection head 310 is movably connected to the end of the connecting arm 200 opposite the mounting member 100. The rotating connection assembly 320 is rotatably connected to the connection head 310 around a first rotation axis, and the mounting base 330 is rotatably mounted to the rotating connection assembly 320 around a second rotation axis. The mounting base 330 can be designed for installing a display. In some aspects, the first rotation axis and the second rotation axis are arranged in a crossed manner, such as being perpendicular or substantially perpendicular to each other. The rotating connection assembly 320 allows the mounting base 330 to rotate relative to the connection head 310 around the first and second rotation axes, thereby increasing the degrees of freedom of the mounting base 330 and enhancing the adjustability of the display support bracket.

In some aspects, referring to FIG. 5, the connection head 310 is rotatably attached to the connecting arm 200. The connection head 310 is equipped with a shaft passage hole 311, and the connecting arm 200 further includes an adjustment shaft 220. One end of the adjustment shaft 220 features a positioning protrusion 313, while the other end passes through the shaft passage hole 311 and is threadedly engaged with the main arm 210. A third bushing 312 is mounted on the adjustment shaft 220, including a sleeve portion 3121 situated inside the shaft passage hole 311 and a damping portion (e.g., shock absorber) 3122 located outside the shaft passage hole 311. The damping portion 3122 is held between the main arm 210 and the connection head 310. In some aspects, the axis of the shaft passage hole 311 is perpendicular or nearly perpendicular to both the first and the second rotation axes, further enhancing the adjustability of the display support bracket. The interaction between the positioning protrusion 313 and the third bushing 312 provides damping for the relative rotation between the connection head 310 and the connecting arm 200, allowing the connection head 310 to be secured at a desired angle relative to the connecting arm 200.

In some aspects, referring to FIG. 5, the adjustment shaft 220 is fitted with a bearing 314 and a fourth bushing 317. The bearing 314 and the fourth bushing 317 are positioned between the positioning protrusion 313 and the connection head 310, with the fourth bushing 317 located on the side of the bearing 314 away from the positioning protrusion 313. The bearing 314 aids in securing the adjustment shaft 220, while the fourth bushing 317 improves the rotational feel. The combined action of the bearing 314 and the fourth bushing 317 helps prevent the adjustment shaft 220 from loosening during use.

In some aspects, referring to FIG. 5, the main arm 210 is bifurcated to create two parallel branch arms 211. One side of the connection head 310 is clamped between the two branch arms 211, and the shaft passage hole 311 is provided on the portion of the connection head 310 that is clamped between the branch arms 211. One of the branch arms 211 has a threaded through hole 212 that aligns with the shaft passage hole 311, while the other branch arm 211 has an adjustment through hole 213 that also aligns with the shaft passage hole 311. The end of the shaft passage hole 311 opposite to the threaded through hole 212 is coaxially enlarged to create a stepped surface. Both third bushings 312 are stepped in design and are inserted into the end of the shaft passage hole 311 with the stepped surface. The damping portion 3122 of the third bushing 312 is held between the stepped surface and the branch arm 211, so that one side of the damping portion 3122 contacts the main arm 210 and the other side contacts the connection head 310, providing damping when the connection head 310 and the main arm 210 rotate relative to each other. The fourth bushing 317 is held at the end of the shaft passage hole 311 opposite to the stepped surface, with part of the fourth bushing 317 inserted into the shaft passage hole 311 and part extending into the adjustment through hole 213.

A bearing 314, which can be a plane bearing, can also held in the adjustment through hole 213. One side of the plane bearing 314 contacts the fourth bushing 317, while the other side is pressed by the positioning protrusion 313. The end of the adjustment shaft 220 opposite to the positioning protrusion 313 is threaded to engage with the threaded through hole 212. During installation, the end of the adjustment shaft 220 opposite to the positioning protrusion 313 passes through the bearing 314, the fourth bushing 317, the shaft passage hole 311, and the third bushing 312 in sequence, and then screws into the threaded through hole 212 until the positioning protrusion 313 presses against the bearing 314 to the desired extent, completing the installation. The level of rotational damping between the connection head 310 and the main arm 210 can be adjusted by controlling how tightly the positioning protrusion 313 contacts the bearing 314. To make it easier to adjust the tightness of the adjustment shaft 220, a hexagonal slot can be provided on the positioning protrusion 313 for use with a hex wrench.

In some aspects, the connection head 310 can be positioned on only one side of the main arm 210, and the rotatable connections between the connection head 310 and the main arm 210, as well as between the main arms 210, can be achieved using alternative structures.

In some aspects, as shown in FIG. 5, the rotatable connection structure between the main arms 210 can be identical to that between the main arm 210 and the connection head 310, allowing for uniform adjustment of rotational damping at each connection point. Of course, different rotatable connection structures can also be used between the main arms 210.

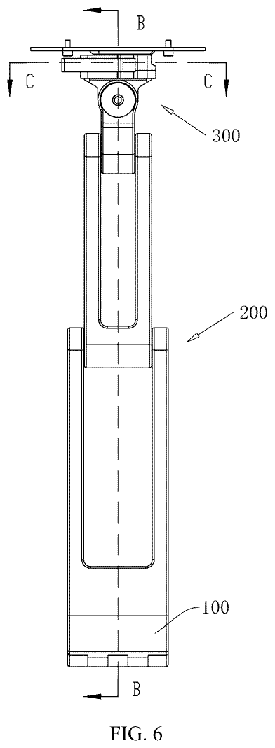

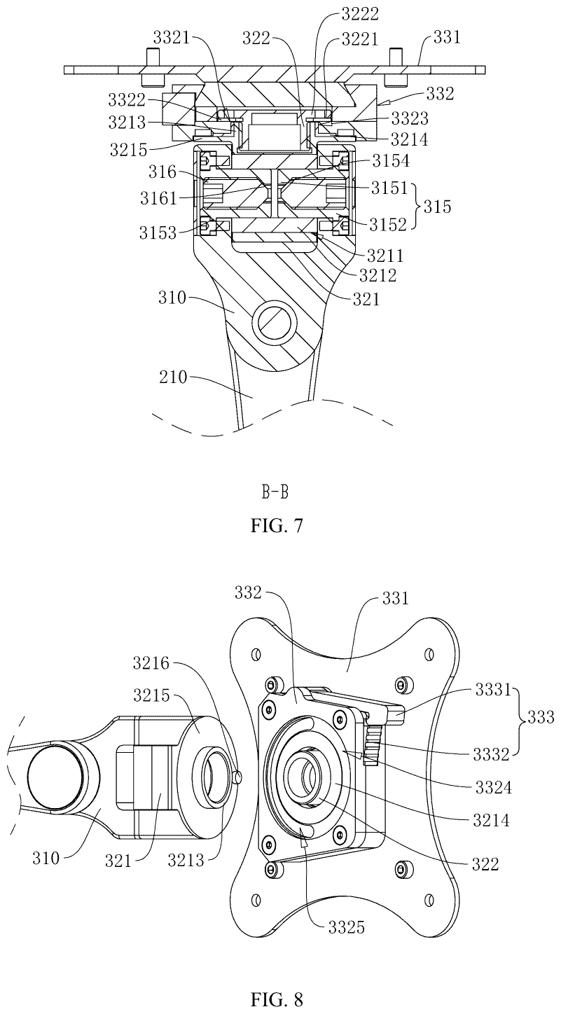

In some aspects, referring to FIGS. 6 and 7, the rotating connection assembly 320 includes a connection body 321 that is rotatably attached to the connection head 310. The connection body 321 has a connection hole 3211, in which a second bushing 3212 is installed. The connection head 310 is equipped with an expansion sleeve 315, which has an expansion end 3151 and a fixed end 3152. The fixed end 3152 of the expansion sleeve 315 is attached to the connection head 310, while the expansion end 3151 is inserted into the inner cavity of the second bushing 3212. The inner wall of the expansion sleeve 315 near the expansion end 3151 has an inclined surface 3154. An adjustment column 316 is movably placed inside the expansion sleeve 315 and can push axially against the inclined surface 3154, causing the expansion end 3151 of the expansion sleeve 315 to expand and press against the inner wall of the second bushing 3212. By controlling the displacement of the adjustment column 316, the degree of expansion of the expansion end 3151 can be adjusted, thereby changing the pressing force between the expansion end 3151 and the second bushing 3212 and enabling the adjustment of the rotational damping between the connection head 310 and the connection body 321. In certain embodiments, the second bushing 3212 can be made of a wear-resistant material, such as engineering plastic, to enhance durability.

In some aspects, the end of the adjustment column 316 adjacent to the expansion end 3151 of the expansion sleeve 315 can further feature a tapered surface 3161, which corresponds to the inclined surface 3154. This design enables the adjustment column 316 to expand the expansion end 3151 by pushing against the inclined surface 3154.

In some aspects, referring to FIGS. 6 and 7, the connection head 310 is designed as a Y-shaped structure with two prongs on one side. The end of the connection body 321 that is rotatably connected to the connection head 310 is inserted between these two prongs. Two expansion sleeves 315 are provided, with the expansion ends 3151 of both extending through corresponding sections of the connection head 310 and into the second bushing 3212. The fixed ends 3152 of the expansion sleeves 315 are equipped with integral annular bosses 3153, which are fastened to the connection head 310 using fasteners, thereby securing the expansion sleeves 315 on the connection head 310. The end of the adjustment column 316 with the tapered surface 3161 is threadedly engaged with the expansion sleeve 315 and positioned close to the expansion end 3151, aligning the tapered surface 3161 with the inclined surface 3154. This configuration allows the expansion degree of the expansion end 3151 to be adjusted by rotating the adjustment column 316. In some embodiments, the adjustment column 316 can be a set screw, and a hexagonal slot can be provided on the side near the fixed end 3152 of the expansion sleeve 315 to adjust the adjustment column 316 with a hex wrench.

In some aspects, the connection head 310 can adopt different structural forms, and the rotatable connection between the connection body 321 and the connection head 310 can utilize alternative mechanisms, provided that the rotating connection assembly 320 can achieve a rotatable connection with the connection head 310.

In certain embodiments, referring to FIGS. 7 and 8, the rotating connection assembly 320 further includes a rotating mating member 322, which is connected to the connection body 321 and is movably engaged with the mounting base 330, enabling the connection body 321 to rotate relative to the mounting base 330 about the second rotation axis.

In some aspects, the side of the mounting base 330 adjacent to the connection body 321 is equipped with a limiting hole. The connection body 321 features a cylindrical sleeve portion 3213, which is inserted into the limiting hole to enable rotatable engagement between the connection body 321 and the mounting base 330. One end of the rotating mating member 322 is connected to the cylindrical sleeve portion 3213, while the other end is movably inserted into the limiting hole along the second rotation axis, allowing the rotating mating member 322 to be movably engaged with the mounting base 330. Through this connection, the mounting base 330 can rotate relative to the connection body 321.

In some aspects, the limiting hole is a stepped hole 3321, and the cylindrical sleeve portion 3213 is inserted into the stepped hole 3321. The term “stepped hole” denotes a hole with a stepped inner wall that includes a reduced-diameter section. The stepped surface of the stepped hole 3321 faces away from the connection body 321. The end of the rotating mating member 322 inserted into the stepped hole 3321 is equipped with an abutment limiting surface 3221, which abuts against the stepped surface of the stepped hole 3321. In alternative embodiments, the limiting hole can be a tapered hole or another type of hole that accommodates the movable insertion of the rotating mating member 322.

In some aspects, the mounting base 330 includes an adapter base 332 and a base body 331 mounted on the adapter base 332. The base body 331 is used for installing the display. The center of the side of the adapter base 332 adjacent to the connection body 321 is equipped with a stepped hole 3321, the central axis of which serves as the second rotation axis. The stepped surface of the stepped hole 3321 faces away from the connection body 321, and the cylindrical sleeve portion 3213 is inserted into the stepped hole 3321. The cylindrical sleeve portion 3213 is internally threaded, and one end of the rotating mating member 322 is inserted into the cylindrical sleeve portion 3213 and threadedly connected to it, facilitating assembly. The other end of the rotating mating member 322 is inserted into the stepped hole 3321 along the second rotation axis and features an engagement portion with an abutment limiting surface 3221 that abuts against the stepped surface of the stepped hole 3321. This arrangement allows the rotating mating member 322 to be rotatably positioned within the stepped hole 3321. In some embodiments, the engagement portion can be configured as an annular protrusion 3222. In some embodiments, to enhance the rotational damping effect between the rotating connection assembly 320 and the mounting base 330, referring to FIGS. 7 and 8, the cylindrical sleeve portion 3213 can be fitted with a first bushing 3214 to increase rotational damping. Additionally, a spacer washer 3322 is provided between the stepped surface of the stepped hole 3321 and the abutment limiting surface 3221 to further enhance rotational damping.

In some aspects, the inner wall of the stepped hole 3321 near the connection body 321 and the sidewall of the adapter base 332 facing the connection body 321 are equipped with embedding grooves 3323 to accommodate the first bushing 3214. The first bushing 3214 has a stepped shape and is embedded in the embedding grooves 3323, providing damping for the relative rotation between the adapter base 332 and the connection body 321. The spacer washer 3322 can be placed on the stepped surface of the stepped hole 3321, with its side opposite to the stepped surface abutting the abutment limiting surface 3221, thereby providing damping for the relative rotation between the rotating mating member 322 and the adapter base 332. The combined action of the first bushing 3214 and the spacer washer 3322 provides damping for the relative rotation between the connection body 321 and the adapter base 332.

In some aspects, depending on the desired damping effect, only the first bushing 3214 fitted on the cylindrical sleeve portion 3213 can be used to increase rotational damping, or only the spacer washer 3322 on the stepped surface of the stepped hole 3321 can be employed.

In some aspects, referring to FIG. 8, the connection body 321 is equipped with a convex ring 3215, and the side of the mounting base 330 adjacent to the connection body 321 is equipped with a receiving cavity 3324 to accommodate the convex ring 3215. The side of the convex ring 3215 adjacent to the mounting base 330 is equipped with a limiting protrusion 3216, while the cavity wall of the receiving cavity 3324 opposite to the convex ring 3215 is equipped with a limiting groove (e.g., a slot or a channel) 3325. The limiting groove 3325 accommodates the limiting protrusion 3216 to restrict the relative rotation range between the connection body 321 and the mounting base 330.

In some aspects, the limiting protrusion 3216 is configured as a limiting post, and both the receiving cavity 3324 and the limiting groove 3325 are provided on the adapter base 332. The limiting groove 3325 is semicircular in shape, into which the limiting post is inserted. By setting the limiting protrusion 3216 and the limiting groove 3325, the relative rotation between the connection body 321 and the mounting base 330 can be confined within a specific angular range, such as 0° to 180°, for example.

In some aspects, a limiting groove 3325 can be provided on the side of the convex ring 3215 adjacent to the adapter base 332, while a limiting protrusion 3216 can be situated on the cavity wall of the receiving cavity 3324 opposite the convex ring 3215.

Given the variety of display types—such as monitors, smartphones, and tablets—which can all function as displays, the base body 331 can assume different forms across various embodiments. In some embodiments, the base body 331 can be a mounting plate fitted with mounting screws to secure a display, like an Apple XDR monitor. In other embodiments, it can incorporate a clamping member, such as smartphone or tablet clamps. In yet other embodiments, a magnetic attachment system, such as a magnetic mount capable of holding smartphones or tablets, can be utilized to support their use as displays. In essence, any structural component capable of securing any type of display can serve as the base body 331.

In some embodiments, to accommodate different types of displays, referring to FIG. 8-10, the base body 331 is detachably connected to the adapter base 332 via a quick-release mechanism. In some aspects, the base body 331 is equipped with a quick-release plate 3311, while the adapter base 332 features a quick-release groove 3326 for inserting the quick-release plate 3311. The adapter base 332 is further fitted with a locking component 333 to secure the quick-release plate 3311 within the quick-release groove 3326.

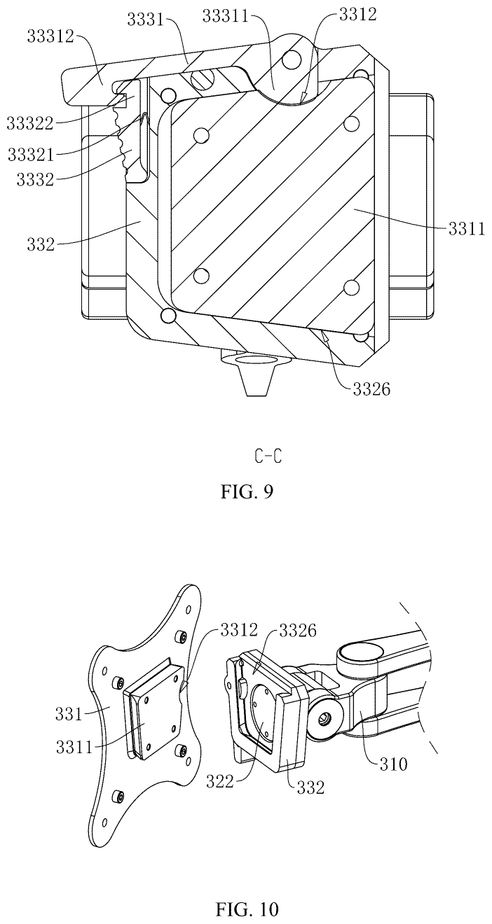

In some aspects, referring to FIGS. 9 and 10, one side of the quick-release plate 3311 is provided with a locking groove 3312. The locking component 333 includes a locking member 3331 and a locking switch 3332. The locking member 3331 is movably mounted on the adapter base 332 and includes a locking protrusion 33311. The locking member 3331 has a locked position in which the locking protrusion 33311 presses into the locking groove 3312. The locking switch 3332 is elastically mounted on the adapter base 332 and serves to retain the locking member 3331 in the locked position.

In some aspects, referring to FIG. 9, the locking member 3331 includes a locking lever rotationally connected to the adapter base 332. The locking lever has an eccentric head that functions as the locking protrusion 33311. The locking switch 3332 is rotationally connected to the adapter base 332, with an elastic member 33321 positioned between the locking switch 3332 and the adapter base 332. The locking switch 3332 is elastically connected to the adapter base 332 via the elastic member 33321. The locking switch 3332 is equipped with a first engagement portion 33322, while the locking member 3331 has a second engagement portion 33312. The second engagement portion 33312 engages with the first engagement portion 33322, enabling the locking switch 3332 to retain the locking member 3331 in the locked position.

In some aspects, referring to FIG. 9, the locking lever is rotationally connected to one side of the adapter base 332, while the locking switch 3332 is rotationally connected to an adjacent side. Both the locking lever and the locking switch 3332 are rotationally connected to the adapter base 332 via pivot shafts, with their axes of rotation parallel to the second rotation axis. The first engagement portion 33322 is located at the end of the locking switch 3332 distal to its pivot shaft, and the second engagement portion 33312 is positioned at the end of the locking lever distal to its pivot shaft. Both the first and second engagement portions 33322 and 33312 feature engagement slots. When the locking lever is in the locked position, the slots on the first and second engagement portions 33322 and 33312 interlock, enabling the locking switch 3332 to secure the locking lever in place.

In some aspects, the elastic member 33321 can be a compression spring, with one end inserted into the adapter base 332 and the other into the locking switch 3332. This arrangement provides an elastic force that biases the locking switch 3332 to rotate away from the adapter base 332, ensuring that the locking switch 3332 retains the locking lever in the locked position and prevents loosening.

In some aspects, referring to FIG. 9, both the first engagement portion 33322 and the second engagement portion 33312 have contact surfaces, which can be inclined or curved. This design allows the locking lever to push the locking switch 3332 to rotate via the contact surfaces while being rotated into the locked position. Once the locking lever reaches the locked position, the locking switch 3332 automatically locks it in place under the force of the elastic member 33321, facilitating one-handed operation.

In some aspects, the locking component 333 can employ a self-locking lever. Alternatively, the locking member 3331 can utilize a latch, bolt, or other locking mechanism capable of securing the quick-release plate 3311 within the quick-release groove 3326. The elastic member 33321 can also be replaced with elastic rubber, a metal spring plate, or other elastic components capable of providing elastic force.

In some aspects, to facilitate assembly, the adapter base 332 adopts a split design, including a first base body 331 adjacent to the base body 331 and a second base body 331 adjacent to the rotating body. The first and second base bodies 331 are connected via bolts. The quick-release groove 3326 and locking component 333 are located on the first base body 331, while the stepped hole 3321 and rotating mating member 322 are positioned on the second base body 331.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A display support, comprising:
a mounting member, wherein the mounting member is configured for mounting an external installation base;
a connecting arm connected to the mounting member;
and a display carrier, wherein the display carrier comprises a connection head, a rotating connection assembly, and a mounting base;
wherein the connection head is movably connected to an end of connecting arm away from the mounting member;
wherein the rotating connection assembly is rotatably connected to the connection head around a first rotation axis;
wherein the mounting base is rotatably mounted to the rotating connection assembly around a second rotation axis; and
wherein the mounting base is configured for mounting a display.

2. The display support according to claim 1, wherein the rotating connection assembly comprises:
a connection body, wherein the connection body and the connection head are rotatably connected about the first rotation axis; and
a rotating mating member, wherein the rotating mating member is connected to the connection body and movably connected with the mounting base, enabling the connection body to be rotatable relative to the mounting base around the second rotation axis.

3. The display support according to claim 2, wherein the mounting base is provided with a limiting hole on a side adjacent to the connection body;
wherein the connection body comprises a cylindrical sleeve portion;
wherein the cylindrical sleeve portion is inserted into the limiting hole to enable rotational cooperation between the connection body and the mounting base; and
wherein one end of the rotating mating member is connected to the cylindrical sleeve portion, and another end of rotating mating member is movably inserted into the limiting hole along the second rotation axis to enable movable connection between the rotating mating member and the mounting base.

4. The display support according to claim 3, wherein the limiting hole is configured as a stepped hole;
wherein a step surface of the stepped hole faces away from the connection body;
wherein an end of the rotating mating member movably inserted into the stepped hole comprises an abutment limiting surface, and the abutment limiting surface is configured to abut against the step surface of the stepped hole; and
wherein a spacer washer is provided between the step surface and the abutment limiting surface to increase rotational damping.

5. The display support according to claim 3, wherein the limiting hole is configured as a stepped hole;
wherein a step surface of the stepped hole faces away from the connection body;
wherein an end of the rotating mating member movably inserted into the stepped hole comprises an abutment limiting surface, and the abutment limiting surface is configured to abut against the step surface of the stepped hole; and
wherein a first bushing is sleeved on the cylindrical sleeve portion to increase rotational damping.

6. The display support according to claim 2, wherein the connection body comprises a convex ring, the mounting base comprises a receiving cavity on a side adjacent to the connection body, and the receiving cavity is configured for accommodating the convex ring; and
wherein the convex ring comprises a limiting protrusion on a side adjacent to the mounting base, and a cavity wall of the receiving cavity opposite to the convex ring is provided with a limiting groove;

7. The display support according to claim 2, wherein the connection body comprises a convex ring, the mounting base comprises a receiving cavity on a side adjacent to the connection body, and the receiving cavity is configured for accommodating the convex ring;
wherein the convex ring is provided with a limiting groove on a side adjacent to the mounting base, and a cavity wall of the receiving cavity opposite to the convex ring comprises a limiting protrusion; and
wherein the limiting groove is configured to accommodate the limiting protrusion to restrict a relative rotation range between the connection body and the mounting base.

8. The display support according to claim 1, wherein the rotating connection assembly is provided with a connection hole;
wherein a second bushing is retained within the connection hole;
wherein the connection head comprises an expansion sleeve;
wherein the expansion sleeve comprises an expansion end and a fixed end;
wherein the fixed end of the expansion sleeve is connected to the connection head;
wherein the expansion end of the expansion sleeve is inserted into an inner cavity of the second bushing;
wherein an inner wall of the expansion sleeve adjacent to the expansion end comprises an inclined surface;
wherein an adjustment column is movably disposed in the expansion sleeve; and
wherein the adjustment column is configured to push the inclined surface along an axial direction of the expansion sleeve, enabling the expansion end of the expansion sleeve to expand and abut against a cavity wall of the inner cavity of the second bushing.

9. The display support according to claim 1, wherein the mounting base comprises:
an adapter base, wherein the adapter base is rotatably connected to the rotating connection assembly; and
a base body, wherein the base body is detachably disposed on the adapter base, and the base body is configured for mounting a display;
wherein the base body comprises a quick-release plate;
wherein the adapter base comprises a quick-release groove for insertion of the quick-release plate; and
wherein the adapter base comprises a locking component configured to lock the quick-release plate in the quick-release groove.

10. The display support according to claim 1, wherein the connection head comprises a shaft passage hole;
wherein the connecting arm comprises a main arm and an adjustment shaft;
wherein one end of the adjustment shaft comprises a positioning protrusion;
wherein another end of the adjustment shaft passes through the shaft passage hole to threadedly connect to the main arm;
wherein a third bushing is sleeved on the adjustment shaft;
wherein the third bushing comprises a sleeve portion located in the shaft passage hole and a damping portion located outside the shaft passage hole; and
wherein the damping portion is between the main arm and the connection head.

11. The display support according to claim 10, wherein a fourth bushing and a bearing are sleeved on the adjustment shaft;
wherein the fourth bushing and the bearing are provided between the positioning protrusion and the connection head; and
wherein the fourth bushing is located on a side of the bearing away from the positioning protrusion.

12. The display support according to claim 11, wherein the connecting arm comprises at least two main arms that are sequentially rotatably connected;
wherein one of the at least two main arms comprises a rotating connecting shaft, and another of the at least two main arms is provided with a pivot hole;
wherein the rotating connecting shaft is inserted into the pivot hole to enable rotatable connection between the at least two main arms; and
wherein a fifth bushing is sleeved on the rotating connecting shaft, and at least part of the fifth bushing is clamped between the at least two main arms.
